(19) United States
(12) Patent Application Publication
(10) Pub. No.: US 2002/0154363 A1
(43) Pub. Date: Oct. 24, 2002

(54) Universal fiber optics network

(75) Inventor: Alain Granger, Raleigh, NC (US)

Correspondence Address: SUGHRUE MION, PLLC, 2100 Pennsylvania Avenue, NW, Washington, DC, 20037-3213, US

(73) Assignee: ALCATEL

(21) Appl. No.: 10/128,357

(22) Filed: Apr. 24, 2002

Related U.S. Application Data
(60) Provisional application No. 60/285,710, filed on Apr. 24, 2001.

(51) Int. Cl. H04B 10/20; H04J 14/00; H04B 10/00

(52) U.S. Cl. 359/152; 359/118

(57) ABSTRACT

A fiber optics network has a physical layer that can accommodate HFC type CATV communications or G.983.1 type communications. Downstream communications are performed using HFC to take advantage of the multiple simultaneous broadcast capability. Upstream communications are performed using G.983.1 to take advantage of the resistence to ingress noise and the more standardized approach offered by G.983.1.

### CROSS-REFERENCE TO RELATED APPLICATIONS

This application claims the benefit of U.S. Provisional Application No. 60/285,710, filed Apr. 24, 2001, which is incorporated by reference, herein, in its entirety.

### FIELD OF THE INVENTION

This invention relates generally to fiber optics networks. In particular, it relates to a new, hybrid approach to carrying communications over an optical distribution network.

### BACKGROUND OF THE INVENTION

Fiber in the Loop (FITL) systems include systems such as hybrid fiber coax (HFC) and those formerly referred to as GX-FSAN, now known as ITU-T G.983.1 (referred to, hereinafter, as G.983.1).

The G.983.1 type system is a well-defined concept providing open optical interfaces, but the HFC type system has not always been well-defined. In actual implementation, the HFC type system may include, in an upstream direction, an open spectrum used for the transmission of proprietary channels and protocols.

The weakest point in HFC type networks is in the transfer mode of upstream non-video services channels that are proprietary and likely to be sub-optimum in terms of performance due to intrinsic impairments of the upstream path.

On the other hand, the transfer of video channels downstream in HFC is rather straightforward, and holds the advantageous property of being compatible with existing audiovisual equipment. Furthermore, there is no limitation in the number of channels simultaneously displayed at the customer premises to feed various subscriber's TV terminals.

In the case of the G.983.1 type system, the video transfer is typically performed in a switched mode since a broadcast transmission is limited by the data rate of the G.983.1 downstream path. In this mode the simultaneous display of a number of video channels becomes rapidly cumbersome and costly. The advantage of an unlimited number of channels for G.983.1 has some limits since it can also be provided in HFC as well, using dedicated video on demand channels. Moreover, some operators may want to restrict the use of the switched access to video on demand schemes and thus prevent from operating broadcast services with a sufficient capacity.

### SUMMARY OF THE INVENTION

According to the invention, a hybrid optical distribution network is described in which HFC is used for the downstream communications, and G.983.1 is used for upstream communications. Since the optical distribution network used for G.983.1 is compatible with operation under HFC, the strong points of both systems can be achieved in one hybrid system.

The invention is taught below by way of various specific exemplary embodiments explained in detail, and illustrated in the enclosed drawing figures.

### BRIEF DESCRIPTION OF THE DRAWINGS

The drawing figures depict, in highly simplified schematic form, embodiments reflecting the principles of the invention. Many items and details that will be readily understood by one familiar with this field have been omitted so as to avoid obscuring the invention. In the drawings:

FIG. 1 shows the physical layer of an optical distribution network according to the HFC or G.983.1 systems.

FIG. 2 graphically depicts the manner in which the spectrum of an HFC system is allocated.

FIG. 3 graphically depicts the manner in which the spectrum of a G.983.1 system is allocated.

FIG. 4 graphically depicts spectrum allocation in one embodiment of the invention.

FIG. 5 graphically depicts spectrum allocation in another embodiment of the invention.

### DETAILED DESCRIPTION

The invention will now be taught using various exemplary embodiments. Although the embodiments are described in detail, it will be appreciated that the invention is not limited to just these embodiments, but has a scope that is significantly broader. The appended claims should be consulted to determine the true scope of the invention.

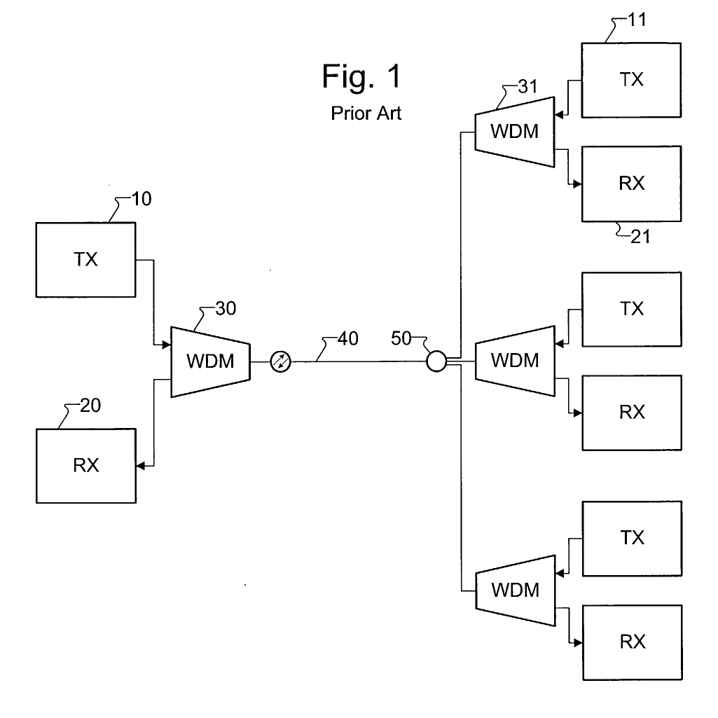

Referring now to FIG. 1, there is shown a physical layer for an optical distribution network. This physical layer is the type that supports either HFC or G.983.1 systems. In particular, reference numeral 10 indicates an optical transmitter at the central office or head end (alternatively referred to as a provider end); 20 indicates an optical receiver at the central office or head end; 30 indicates a wavelength division multiplexer; 40 indicates the optical fiber; 50 indicates a 1:n optical coupler; 31 indicates wavelength division multiplexers at the user end; 11 indicates an optical transmitter at the user end; and 21 indicates an optical receiver at the user end.

The downstream direction is from transmitter 10 to receivers 21; the upstream direction is from transmitters 11 to receiver 20.

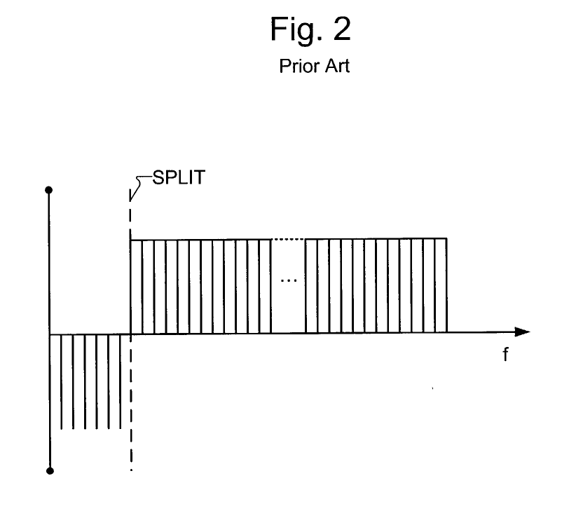

Turning to FIG. 2, there is shown the spectrum used in an HFC type distribution network. In particular, there is a split in the HFC system between the upstream and downstream portions of the spectrum. The downstream portion of the spectrum is used to carry the CATV programming from the head end to the user end. The upstream portion is for carrying telephone over cable, data over cable, or inbound video from the user end to the head end.

Understandably, the majority of the spectrum is dedicated to carrying CATV channels downstream. The split between the upstream and downstream portions of the bandwidth may be as low as about 54 MHz, and up to as high as about 192.5 MHz.

Even though not all HFC systems operate in an identical manner, such systems can be referred to as operating according to an HFC protocol, for the sake of linguistic convenience.

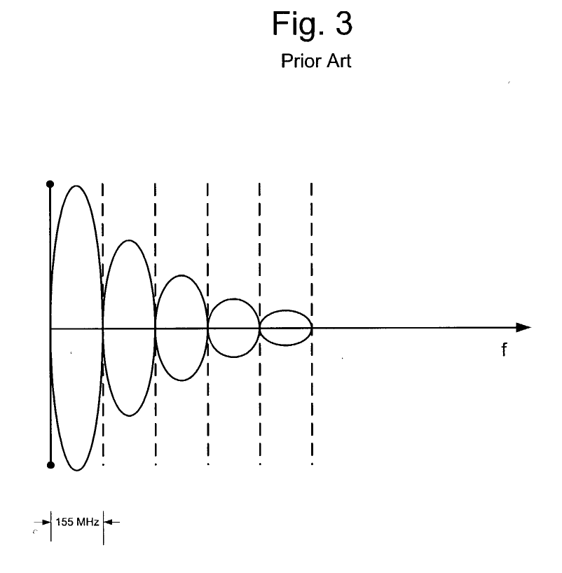

Turning now to FIG. 3, there is shown the manner in which the spectrum is used in a G.983.1 system. In particular, the spectrum is contained within the limits of the upstream bandwidth defined by the split.

Under the HFC system, there is no limit to the simultaneous display of CATV channels. Another advantage to the HFC system is that the number of channels is scalable. One problem has been that the upstream portion of the spectrum has been poorly defined. That is to say, certain CATV providers use a proprietary scheme for the allocation of bandwidth in the upstream portion. Furthermore, the upstream spectrum is very sensitive to ingress distortion (i.e., noise from appliances and the like).

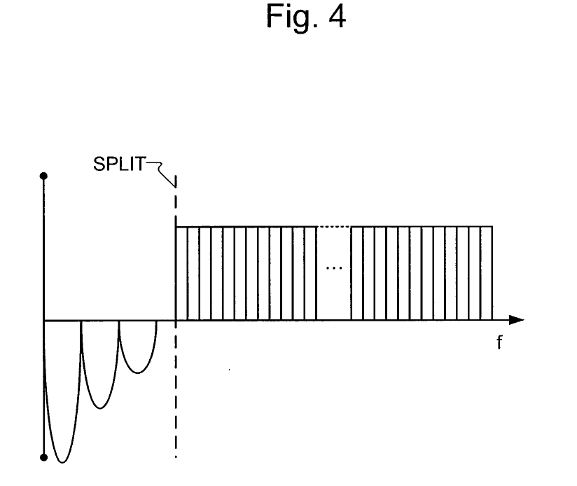

One preferred embodiment of the invention is shown in FIG. 4. In FIG. 4, the downstream traffic is carried in a manner according to the HFC system approach, but the upstream traffic is carried according to G.983.1. The same physical layer (i.e. the layer shown in FIG. 1) is used, but the optical distribution network operates according to a hybrid approach. This preserves the advantage of the HFC system whereby the simultaneous display of multiple channels is permitted, but avoids the disadvantages of the HFC system of proprietary upstream spectrum allocation, and susceptibility to ingress noise. That is to say, using G.983.1 upstream provides a standardized approach, it also makes the signal more resistant to ingress noise.

This hybrid approach allows for a consistent migration towards FTTH, which is the ultimate technological evolutionary stage of access systems for both CATV operators and local exchange carriers.

In summary, there has been described a system designed around the superposition of the physical layers of G.983.1 and HFC. To achieve this objective, a light wavelength division multiplexing scheme is used downstream.

It should be pointed out that a spectral shaping of the incoming NRZ signal at 155 Mbps may be used before the G.983.1 service node transmitter to attenuate the side lobes. This spectral shaping can make the use of a simple Nyquist filter with control of the NRZ side lobes' attenuation.

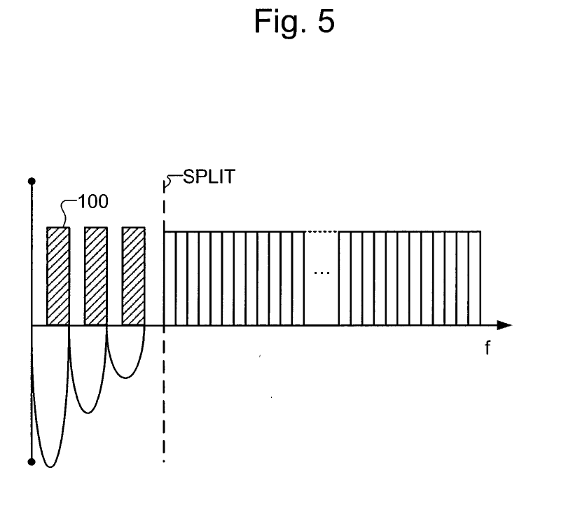

FIG. 5 shows another embodiment of the invention. According to this embodiment, there is used either a baseband digital signal with a multilevel line code or a digitally modulated subcarrier (16 or 64QAM). The advantage of this arrangement is that the capacity of the G.983.1 path becomes scalable by increments of 155 Mbps by adding more subcarriers 100 in the inbound split area.

Many variations to the above-identified embodiments are possible without departing from the scope and spirit of the invention.

There is claimed:

1. A fiber optic network system, comprising:
a physical layer, including a provider-end transceiver connected to a user-end transceiver via a fiber optic cable;
downstream communications from the provider-end transceiver to the user-end transceiver being carried according to a HFC protocol; and
upstream communications from the user-end transceiver being carried according to a G.983.1 protocol.

2. The fiber optic network system as set forth in claim 1, wherein the upstream communications include a plurality of subcarriers in an inbound split area.

3. The fiber optic network system as set forth in claim 2, wherein the plurality of subcarriers is implemented using a baseband digital signal with a multilevel line code.

4. The fiber optic network system as set forth in claim 2, wherein the plurality of subcarriers is implemented as digitally modulated subcarriers.

5. The fiber optic network system as set forth in claim 4, wherein the digitally modulated subcarriers are modulated at one of 16 and 64 QAM.

6. A fiber optic communication method, comprising:
carrying downstream communications from a provider-end to a user-end according to a HFC protocol; and
carrying upstream communications from the user-end to the provider-end according to a G.983.1 protocol;
wherein the downstream communications and the upstream communications are carried over the same physical layer via a fiber optic cable.

7. The fiber optic communication method as set forth in claim 6, wherein the carrying of the upstream communications includes carrying a plurality of subcarriers in an inbound split area.

8. The fiber optic communication method as set forth in claim 7, wherein the plurality of subcarriers is implemented using a baseband digital signal with a multilevel line code.

9. The fiber optic communication method as set forth in claim 7, wherein the plurality of subcarriers is implemented as digitally modulated subcarriers.

10. The fiber optic communication method as set forth in claim 9, wherein the digitally modulated subcarriers are modulated at one of 16 and 64 QAM.
